(19) United States
(12) Patent Application Publication
(10) Pub. No.: US 2007/0197281 A1
(43) Pub. Date: Aug. 23, 2007

(54) Methods And Systems For Conducting Pari-Mutuel Wagers

(76) Inventor: Frank Stronach, Oberwaltersdorf (AT)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/531,355

(22) Filed: Sep. 13, 2006

Related U.S. Application Data
(60) Provisional application No. 60/716,076, filed on Sep. 13, 2005.

(51) Int. Cl. G06F 19/00

(52) U.S. Cl. 463/28; 463/9; 463/16

(57) ABSTRACT

Methods and systems of conducting wagers, such as pari-mutuel wagers. In one exemplary embodiment an event, such as a horse race, dog race, a combination of races, etc., is identified for which a plurality of bettors may each place at least one wager. Preferably, the racing wager method comprises the steps of: (i) providing a bettor with a selection from among a plurality of runners at four races; (ii) accepting a wager from the bettor, said wager comprising (iia) a monetary amount, and (iib) the bettor's selection of runners for the first, second, and third place finishers for each of the four races; and (iii) providing monetary value to a bettor whose wager meets a predetermined wager success criteria.

This application claims the benefit of U.S. Provisional Application No. 60/716,076, filed Sep. 13, 2005, incorporated herein by reference.

### BACKGROUND OF THE INVENTION

1. Field of the Invention

The present invention generally relates to pari-mutuel wagering and, more particularly, to methods of conducting such wagering activities including, for example, methods and systems for accepting and pricing pari-mutuel wagers.

2. State of the Art

Pari-mutuel wagering essentially includes the placing of wagers by a plurality of individuals on the outcome of an event, wherein the bettors who place “winning” wagers share the betting pool minus a percentage taken out for the management or administration of the wagering activity. For example, pari-mutuel wagering is often associated with racing (e.g., horses or dogs) wherein individuals may place wagers on one or more aspects of the outcome of the race. These aspects may include, for example, which of the participants (also referred to herein as runners) will win the race, the order in which a plurality of runners will finish the race (e.g., exacta-ordered prediction of first and second place; trifecta-ordered prediction of first, second and third place; superfecta-ordered prediction of first through fourth place; etc.), or a runner finishing within a specified range of positions (e.g., a “show” wager for a given runner to finish in either first, second or third place; or a quinella wager for predicting the first and second place finishers regardless of order). See, for example, U.S. patent application Ser. No. 10/982,546, published Jun. 9, 2005 as U.S. 2005/0124410 A1.

For those individuals who have placed a winning wager such that their prediction matches an actual event outcome, their payout is determined, in part, by the difficulty of the wager (e.g., a show wager vs. a trifecta wager), in part, by the size of the pool as defined by the total amount of wagers placed for a given event and, in part, the specific wagers made by other bettors. Thus, for example, if a defined prize pool is to be paid out to those wagers which selected runner X as the winner and, for example, 20 individual wagers were placed on runner X to win, the prize pool will be divided among those 20 bettors in proportion to the amount each of the 20 individual bettors wagered on such an outcome. The wide variety of such wager success criteria are well known in the art and need not be described further herein.

Pari-mutuel wagering is preferred by some individuals because a wager may be “handicapped” in the sense that a bettor may study different facets of an event to make an educated prediction of the outcome of the event prior to placing their wager. For example, in a horse race, a bettor may review the past performances of the horses, the training histories of the horses, the breeding histories of the horses, which jockeys will be participating and other related information. Consideration of such information enables a bettor to make a more educated prediction regarding the outcome of a race or other event.

Many individuals prefer other types of wagering activities, such as slot machines, purchasing of lottery tickets or other conventional wagering activities offered at a casino or a lottery facility, because they find the act of handicapping a pari-mutuel wager to be complex, difficult and time consuming. Furthermore, several hours may pass between the time an individual places a wager on a series of races and the outcome of the wager is made known. Such is in contrast to casino wagering wherein multiple wagers may be placed and the outcome of each be made known in rapid succession, such as with slot machines.

There have been various attempts by pari-mutuel venues to attract the individuals who are attracted either to simpler wagering activities or the potential for a larger payout. For example, random wagers, sometimes referred to as “quick picks,” have been offered at pari-mutuel venues to satisfy those patrons which prefer simpler wagering activities. Such a random wager may include an appropriately configured wagering terminal which is configured to randomly choose the outcome of the event (e.g., the winning runner of a race) on which the bettor places his or her wager. These wagers are added to the pool of wagers or, in other words, commingled with handicapped wagers which have been placed in regards to the same event. However, those individuals that are placing random wagers, such as a quick-pick type wager, may feel disadvantaged by the fact that other bettors are handicapping their wagers and, therefore, that such other bettors may have a better chance at winning a portion of the wagering pool.

Other attempts to attract new patrons, including those who may not be comfortable in handicapped-style wagering, include, for example, those set forth in U.S. Pat. No. 6,309,307 issued to Krause et al., and U.S. Pat. No. 6,152,822 issued to Herbert.

The Krause et al. patent generally describes a method of incorporating casino game attributes with a pari-mutuel wagering activity. For example, a black jack-style game may be played wherein a bettor wagers on whether the sum of the numbers assigned to the first four runners to finish a race will be closer to 21, without going over, than will the sum of the numbers assigned to the last four runners to finish the race. It is noted that such a scheme is still amenable to a bettor handicapping his or her wager. However, it is believed that incorporation of familiar casino or sports betting themes will entice new patrons to frequent pari-mutuel venues.

The Herbert patent generally describes a method of wagering which includes an activity occurring subsequent to at least one pari-mutuel event and which utilizes the outcome of the one or more pari-mutuel events as a “wagering base” for a slot machine type wagering activity. For example, the win, show, exacta and perfecta results of one or more races are selected to comprise the “wagering” base or, in other words, act as the possible outcomes of a slot machine format wagering activity. The odds which were associated with the selected outcomes of the pari-mutuel wagers (win, show, etc.) may be programmed into an appropriate wagering device or system such that, for example, if the odds of a selected perfecta wager (from a previously run race) were 24 to 1 (i.e., a probability of 0.04), the same probability will be assigned to the selected perfecta wager as a potential outcome of the slot machine-style wagering activity. Outcomes from multiple pari-mutuel events or races may be used to build the wagering base and the actual outcome of a “spin” of the slot machine wagering activity is determined by a random number generator based on the probabilities assigned to the various potential outcomes drawn from the wagering base. It is again noted that the slot machine wagering activity is conducted separately from the pari-mutuel events.

Even with schemes such as described in the above-referenced Krause et al., and Herbert patents, other aspects of pari-mutuel wagering stand in need of improvement. For example, an important factor in attracting patron interest is the size of the probable jackpot that a patron can expect to win. Thus, it is desirable to provide relatively large jackpots.

In view of the shortcomings in the art, it would be advantageous to provide a method of pari-mutuel wagering which is attractive to a wide variety of patrons and provides for increased jackpots. It would also be advantageous to provide a method of placing a pari-mutuel wager with a simplified wagering process such that reduces some of the complexity commonly associated with the pari-mutuel form of wagering. Finally, it would also be advantageous to offer multiple prize tiers so that less experienced bettors have an improved opportunity to win despite not being an experienced handicapper.

### SUMMARY OF THE INVENTION

In accordance with one aspect of the invention, a method of conducting a wagering activity is provided. The method includes enabling a plurality of bettors to predict the outcome of a series of four designated events to be conducted in the future, wherein the wager is tied to the bettor's ability to predict the first three finishers, preferably in the exact order of finish, in all four designated events. The events may be conducted by those administering the wager, or may be conducted by one or more other parties and simply monitored by those administering the wager. For example, one aspect of the present invention provides a racing wager method, comprising the steps of: (i) providing a bettor with a selection from among a plurality of runners at four races; (ii) accepting a wager from the bettor, said wager comprising (iia) a monetary amount, and (iib) the bettor's selection of runners for the first, second, and third place finishers for each of the four races; and (iii) providing monetary value to a bettor whose wager meets a predetermined wager success criteria.

In accordance with another aspect of the invention, a method of conducting a wagering activity is provided. The method includes providing for multiple prize tiers to be awarded according to the number of correct selections that one or more bettors have made.

In accordance with yet another aspect of the invention, a method of conducting a wagering activity is provided. The method includes providing for a carryover pool, which carryover pool can build over time in the event bettors are unable to correctly select the first three finishers in all four designated races.

In accordance with a further aspect of the present invention, a system is provided for conducting a pari-mutuel wager. The system includes a computer having at least one processor and at least one memory device. An input device is configured to receive at least one selection from each of a plurality of bettors regarding at least one predicted aspect of an outcome of an event.

In accordance with a further aspect of the present invention, a network is provided. The network includes a plurality of wagering systems operably coupled with each other. At least one of the wagering systems includes a computer having at least one processor and at least one memory device. An input device is configured to receive at least one selection from each of a plurality of bettors regarding an outcome of an event

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a schematic of the process for conducting the wagering activity in accordance with the present invention;

FIG. 2 is a schematic of apparatus which may be used to practice the present invention;

FIG. 3 is a table showing possible odds that could result based on the number of runners in each of the four races.

FIG. 4 is a table showing the tiered prize structure contemplated in accordance with an embodiment of the present invention;

FIG. 5, is an image of a self-service wagering terminal which is designed to allow bettors to place the wager;

FIG. 6 is an image of the screen that provides the options available to a bettor from the self-service wagering terminal; and

FIG. 7 is an image of the wagering screen shown in FIG. 6, showing the appearance of the screen after a bettor has made his or her selections.

### DETAILED DESCRIPTION OF THE PRESENTLY PREFERRED EMBODIMENT

The present invention is directed to a method of wagering, particularly pari-mutuel type wagering, wherein the pool (the combination of wagers placed for a given wagering activity) is comprised of wagers where the bettors attempt to choose the first three finishers in each of four separate races. This type of wager may be termed a “Quad-Trifecta Jackpot” and utilizes, in part, a device named the Horse Wizard™ to permit patrons to select and place their wagers into the said wagering pool However, embodiments may also be used to choose the first 2-6 finishers in each of four or more races. Also, the present invention may be combined with other types of wagers to provide a multi-wager format which may be attractive to certain bettors.

As discussed above, in conventional pari-mutuel wagering activities, the jackpot is inversely related to the ability of the bettor population to predict the outcome of a given event or series of events. Because the predictability of events varies considerably from one event to another, a pari-mutuel venue has little control over the jackpots offered in association with such events. The presently disclosed methods of wagering serve to create substantial jackpots on a more predictable basis due to the large number of permutations that can result based on the number of correct selections that must be made. The increased randomness helps an establishment to operate on a more predictive model since the jackpots are likely to develop due to the decreased likelihood that expert handicappers will be able to predict the outcome of each event.

In an exemplary embodiment of the present invention, four events, such as dog or horse races (referred to hereinafter as races for purposes of convenience), may be conducted. Such races may occur in relatively rapid succession (preferably, the same day, but may be over a multi-day period), and may be run at one or a plurality of tracks or venues wherein races may be monitored from one track to another through an appropriate network or broadcast system, as will be appreciated by those of ordinary skill in the art.

For example, the wagering activity includes four specified races which may have been previously identified by the administrator of the wagering activity. A bettor may pay a specified amount to participate in the wagering activity and then select the first three runners of each race, in accordance with his or her predictions or handicapping activities.

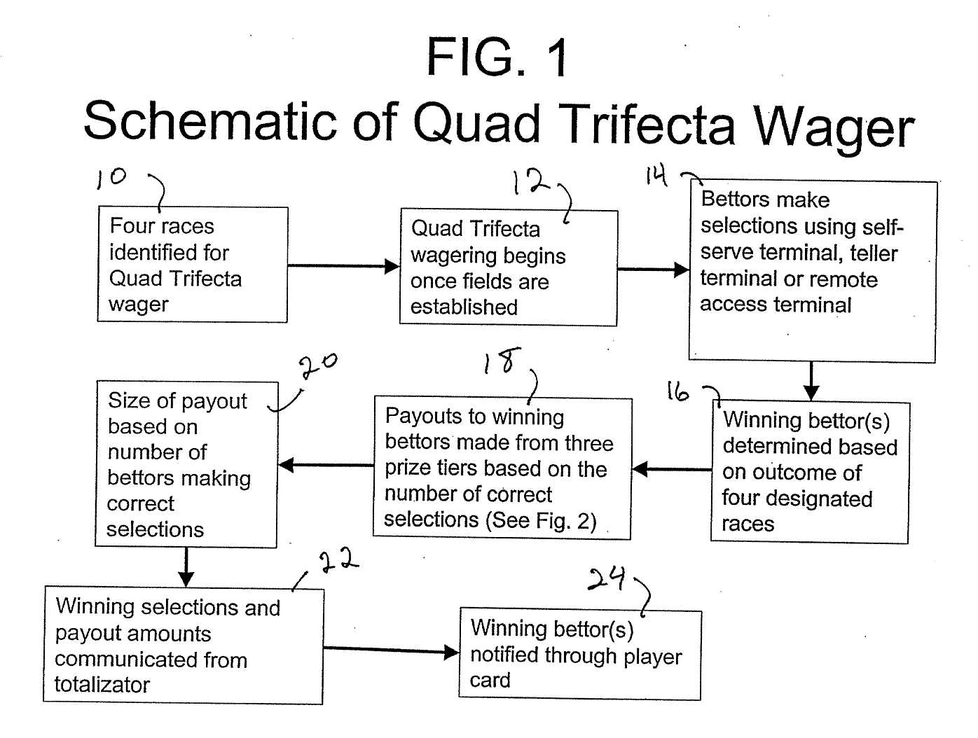

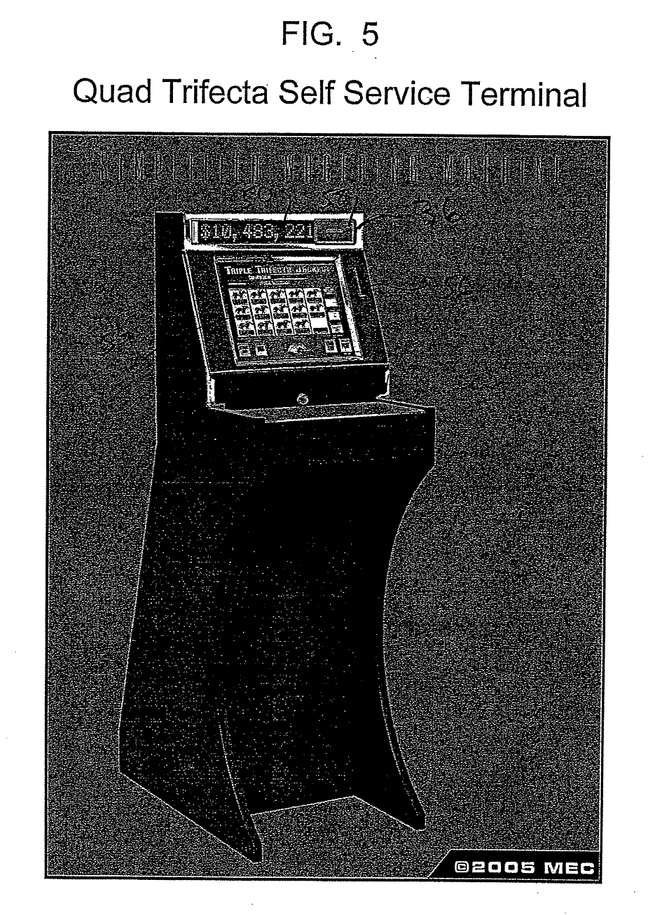

FIG. 1 is a schematic showing the wagering process that is envisioned to occur with the presently preferred embodiment of the present invention. The wager begins with the identification of the four races for the Quad Trifecta wager at box 10; this identification may be performed by the wagering institution pursuant to a non-random selection process in one or more wagering institution servers, but may be fully or at least partially determined by each bettor or pool of bettors. Thereafter, the Quad Trifecta wagering begins once the fields of runners are established in box 12. In box 14, the bettors may make their selections using a self-serve terminal (such as a kiosk, to be discussed below), a terminal operated by a mutuel teller at a pari-mutuel wagering facility, or a remote access terminal (such as a personal computer, a personal digital assistant, a cell phone, etc.). The winning bettor(s) is/are determined by the one or more wagering institution servers, based on the outcome of the four designated races at 16. Payouts to winning bettor(s) are determined by the one or more wagering institution servers, preferably from three prize tiers (to be described below), based on the number of correct selections, at box 18; although one-to-ten (or more) prize tiers may be used. The size of the payout is preferably based on the number of bettors making correct selections in box 20; although other known criteria may be used. In box 22, the winning selections and payout amounts are communicated from one or more wagering institution servers (totalizator) to the bettor(s) self-serve terminal(s), the pari-mutuel wagering facilities' teller-operated terminals, or remote access terminal(s). Finally, in box 24, the winning bettor(s) who use a self-serve terminal as shown in FIG. 5 is/are notified through a player card, which may be traded for cash or other remuneration, as is known in the wagering art.

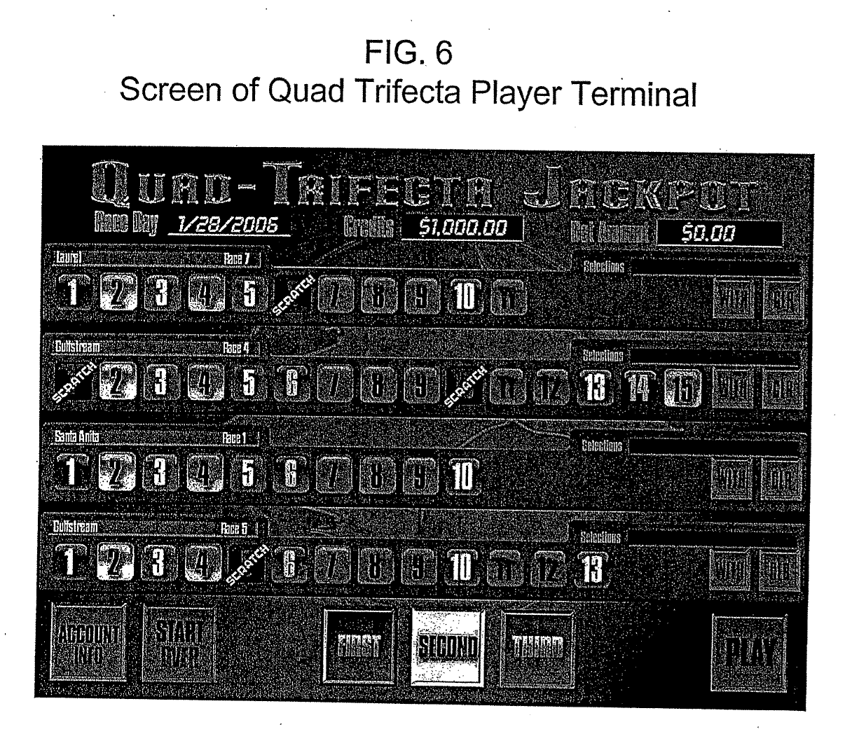

To further demonstrate the steps reflected in FIG. 1, assume the following races have been designated to serve as the four races to be utilized in the Quad Trifecta wager: the 7^{th} race at Laurel Park racetrack, in which there are ten starters, the 4^{th} race at Gulfstream Park, in which there are 13 starters, the first race at Santa Anita Park, in which there are 10 starters, and the 5^{th} race at Gulfstream Park, in which there are 12 starters (see FIG. 6).

The bettor chooses his/her selections according to either a random selection process, the use of handicapping techniques or a combination of the two. Upon choosing his/her selections, the bettor places the wager as follows: In the 7^{th} race at Laurel Park, the bettor chooses either the 2 or 8 horse to win, the 3 or 4 horse to come in second, and the 10 horse to come in third. In the 4^{th} race at Gulfstream Park, the bettor selects the 6 horse to come in first, the seven or eight horse to come in second and the 8, 9 or 12 horse to come in third. In the first race at Santa Anita, the bettor selects the 2 or 6 horse to come in first, the 2 horse to come in second and the 4 horse to come in third. Finally, in the 5^{th} race at Gulfstream Park, the bettor chooses the 2 or the 8 horse to come in first, the 6 or the 8 horse to come in second, and the 10 horse to come in third. Once the selections are made the bettor places the wager and the wager is entered into the collective pari-mutuel wagering pool for the Quad Trifecta Wager.

Further assume that based on the wagers that have been placed, the Major Pool is $8,000,000, the Principal Minor Pool is $1,300,000 and the remaining Minor Pool is $700,000. Now assume that each of the races are conducted resulting in the following orders of finish:

In the 7^{th} race at Laurel Park, the 2 horse wins, the 3 horse places second and the 4 horse comes in third.

In the 4^{th} race at Gulfstream Park, the 7 horse wins, the 8 horse places second and the 9 horse comes in third.

In the first race at Santa Anita Park, the 1 horse wins, the 2 horse places second and the 4 horse comes in third.

In the 5^{th} race at Gulfstream Park, the 2 horse wins, the 6 horse places second and the 10 horse comes in third.

Based on the foregoing outcome, the bettor properly selected 9 out of 12 finishers correctly (the 2 and 3 horses in the first race, the 8 and 9 horses in the second race, the 2 and 4 horses in the third race, and the 2, 6 and 10 horses in the fourth and last race). This would entitle the bettor to share in the Principal Minor Pool along with any other bettors who correctly selected 9, 10 or 11 of the possible 12 finishing positions in the four designated races. Assume also that no bettor correctly selected 12 of 12 finishers in the four designated races, 8 bettors (including the bettor in this example) correctly selected 9, 10, or 11 of the 12 possible finishing positions in the four designated races, and 400 bettors (including the bettor in this example) correctly selected 6 or more of the possible 12 finishing positions in the four designated races. Based on the foregoing outcome, the bettor's share of the Principal Minor and remaining Minor Pool would be $162,500 ($1,300,000/8) and $1,750 ($700,000/400), respectively, for a total of $164,250 ($162,500+$1,750).

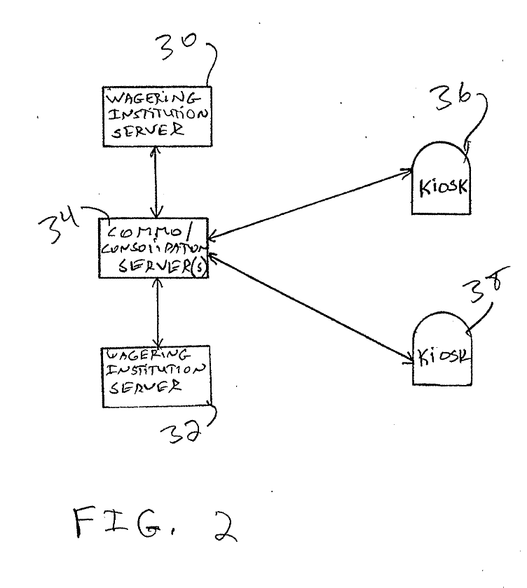

FIG. 2 shows one exemplary apparatus for performing the functions specified in FIG. 1. In FIG. 2, one or more wagering institution servers 30, 32 may be used to identify groups of four races for each Quad Trifecta wager. The servers 30 and 32 may each operate with respect to one or more tracks or venues and/or one of more countries, states, etc. If more than one wagering institution server is involved, a communication and/or consolidation server 34 may be used to consolidate the activities of each wagering institution server 32, 34, and/or to communicate with one or more bettor kiosks (to be described below) 36, 38 through the Internet, cell phone service, personal digital assistant service, etc. Preferably, each server and kiosk comprises a processing device having an appropriate CPU, ROM, RAM, network/Internet interface, computer readable medium, etc. to perform the specified functions. Moreover, software to carry out the specified functions may be incorporated in one or more permanent or removable computer-readable media, such as one or more floppy disks, one or more CD ROMs, one or more PC hard drives, one or more EEPROMs, etc. In addition (or in the alternative) such software may be downloaded (through a shrink-wrap license) to bettors through their personal computers, personal digital assistants, cell phones, etc.

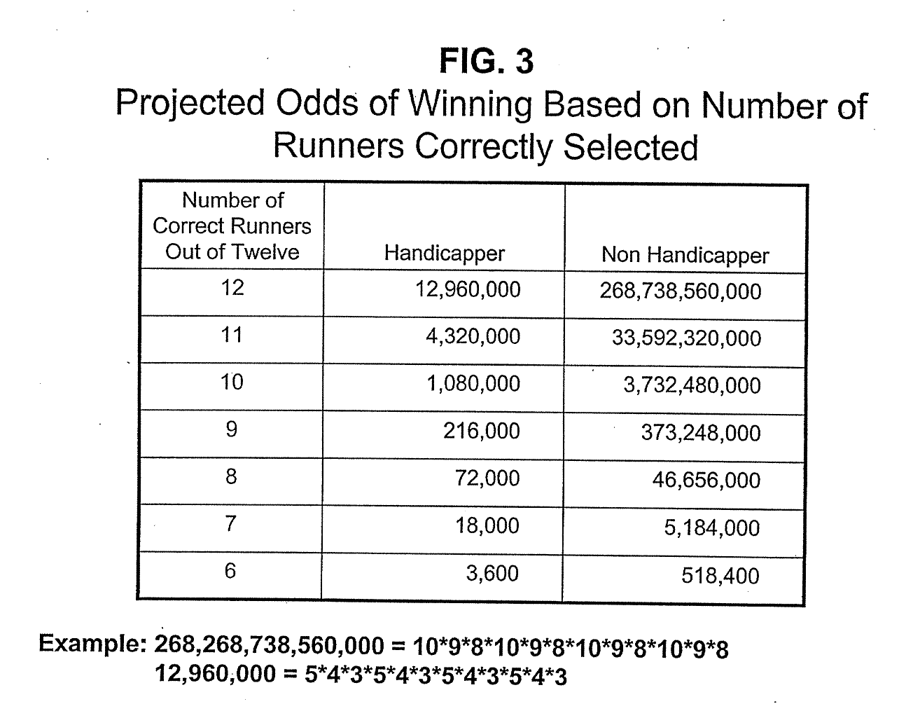

The odds of correctly selecting the first three finishers in all four races, based on an assumed field size of 10 horses per race can be determined using the following formula:
W×(W−1)×(W−2)×X×(X−1)×(X−2)×Y×(Y−1)×(Y−2)×Z×(Z−1)×(Z−2) (1)
where W is equal to the number of runners in the first of four races, X is equal to the number of runners in the second of four races, Y is equal to the number of runners in the third of four races, and Z is equal to the number of runners in the fourth of four races. Assuming ten (10) runners in each of the four designated races, the odds of selecting all 12 horses in correct order are 10×9×8×10×9×8×10×9×8×10×9×8, or approximately 1 in 269 billion. As shown in FIG. 3, the odds of correctly selecting all 12 runners in the four races can be reduced if a bettor is able to handicap one or more races to reduce the effective number of runners below 10.

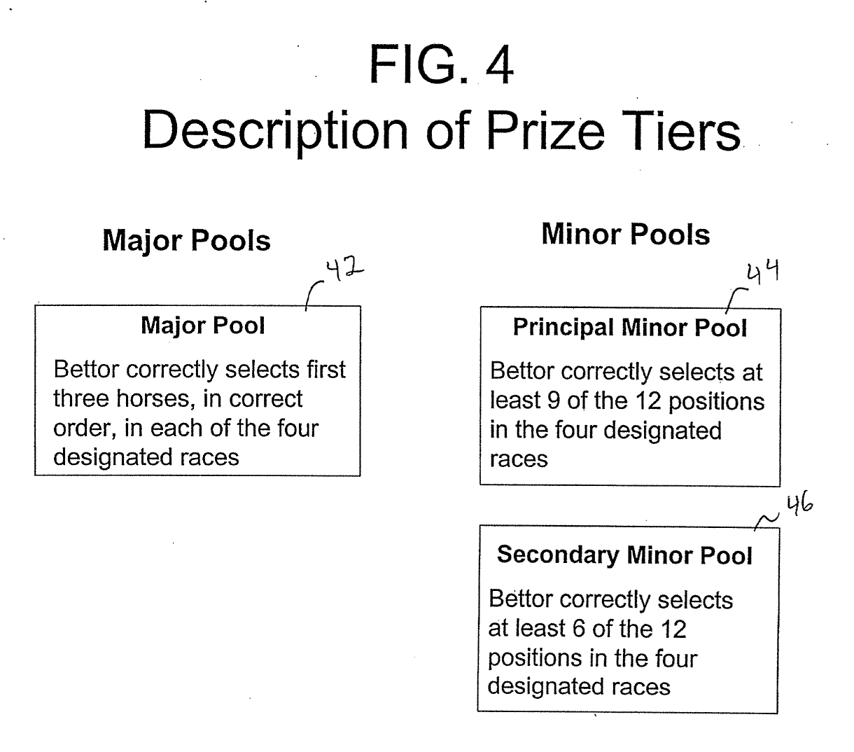

Referring now to FIG. 4, the preferred tiered prize structure is shown, which may be used in conjunction with the wagering methods described with respect to FIG. 1. The exemplary prize structure is based on the exemplary assumptions of an average field size (e.g., the average number of runners or participants in the selected events) being 10, a ticket price (or required wager amount) of $1.00, with 10,000,000 individual wagers being made, a take-out of 25% of the collected wagers being allocated to the administrator of the wagering activity and a top tier jackpot allocation of 60% of the collected wagers. Of course, such criteria may be varied or combined in any reasonable or convenient structure, as is known in the wagering art. In FIG. 4, the Major Pool tier 42 comprises the bettor(s) correctly selecting the first three runners, in their correct order, in each of the four designated races. The Principal Minor Pool tier 44 comprises the bettor(s) correctly selecting at least 9 of the 12 top three positions jn the four designated races. The Secondary Minor Pool 46 comprises the bettor(s) correctly selecting at least 6 of the 12 top three positions in the four designated races. Of course, any number of other prize tiers (two or more) may be provided giving any combination of the top three (or more) runners in the selected number of races (four or more).

In situations where the jackpot of a given tier is not won, preferably, the jackpot (or predetermined or variable portions thereof) may be carried over into, for example, another wagering activity (such as the next day's Quad Trifecta). In another embodiment, jackpots not won (in any tier, not just the highest tier) may be wholly or partially rolled down to one or more designated lower tier levels and distributed, for example, parimutuelly, thereby providing an unanticipated bonus to participants with winning wagers in such designated lower tiers.

Of course, the exemplary embodiments described with respect to FIGS. 1, 2, 3 and 4 need not follow either the exemplary assumptions set forth herein. Rather, variables, such as the take-out, jackpot allocation, average field size, number of tiers and other variables may be altered and different prize structures may be utilized. Using such variables, one of ordinary skill in the art may compute the various odds of winning a specified wagering event and provide a corresponding wager success criteria and prize structure. It is further noted that the above exemplary embodiments readily provide scalability. Thus, the present invention may be tailored to individual venues depending, for example, on the number of patrons attending a given event and the expected level of participation by the patrons in the wagering activity.

FIG. 5 is a perspective view of the kiosk terminal 36 used by the bettor to place his/her bet. The kiosk 36 may include a touch sensitive LED display 52, an LCD display 54, a credit card reader 56 (and/or a cash input slot), and a printer 58 to print out receipts that reflect the wagers placed or winning tickets (and/or a cash output slot). Each kiosk terminal 36 will include appropriate processing structure (as described above) to communicate with the one or more wagering institution servers to accomplish the wagering functions described above.

FIG. 6 is a screen shot of the kiosk LCD display 54, showing possible wagers presented to the bettor. Each horse (e.g., horse numbers 1-11 at Laurel, Race No. 7) at a plurality of horse racing tracks is show (some are scratched). The bettor sequentially touches the “First”, “Second”, and “Third” keys, touching after each one the horse number at each track which corresponds to his/her wager. When first, second, and third horses have been designated for each race, the bettor touches the “Play” button, and the wager is transmitted to the one or more wagering institution servers. “Account Info” and “Start Over” keys are provided to respectively provide account information to the bettor, and to start the wagering process over again in case, for example, the bettor wishes to change his/her bet. The LCD display may also show such information as the race day, the credit the bettor has accumulated, and the wager amount. “With” keys may be added to allow the bettor to combine several horses in on finishing position (e.g., for selecting the 2, 4, and 6 horses to finish second) and “CLEAR” keys may also be used for each race, as shown.

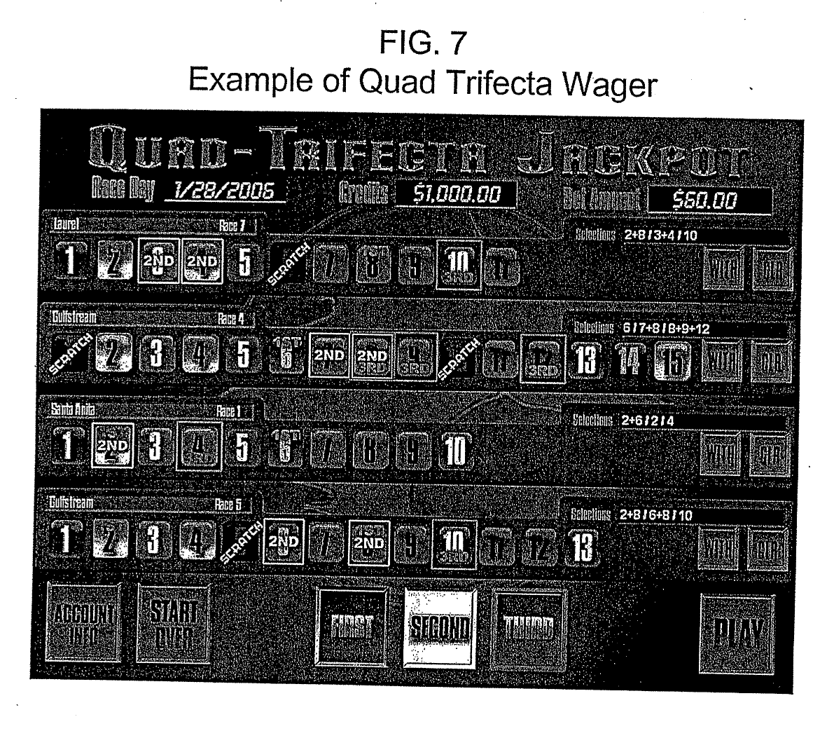

FIG. 7 is a screen shot showing the bettor's completed bet, just prior to touching the “Play” key or button. As shown, the bettor may select two or more horses for each of the first, second, and third positions in each race, but the potential winnings will, of course, be discounted by such a pick. For example, in FIG. 7, in Race 7 at Laurel, the bettor has selected either of horse 2 or horse 8 to come in first, either horse 3 or 4 to come in second, and horse 10 to come in third. By pacing such bets, even non-handicapper bettors have a good chance of winning the bet.

### EXAMPLE

As discussed above, the Quad Trifecta is a form of pari-mutuel wagering on four designated races. The bettor selects the three horses that will finish first, second and third in each of the four designated races of the Quad Trifecta, in each case in the exact order of finish as officially posted. The Quad Trifecta pool is preferably held entirely separate from all other wagering pools, and may not be part of any exacta, triple, daily double, or other wagering pool. The Quad Trifecta is not a parlay wager. Quad Trifecta tickets are sold in approved denominations. The four races which comprise the Quad Trifecta are approved by the appropriate racing authority, and are clearly designated in the program. Quad Trifecta tickets are clearly identified as such, so as to distinguish them from tickets on other wagering pools.

Unless otherwise stated, the major share of the net Quad Trifecta Pool (defined as the total amount wagered less all applicable commissions and taxes under the laws of this State) is distributed as a single price pool to those who selected the first three finishers, preferably in exact position, in a minimum specified number of positions in the four races (considered as a whole) that comprise the Quad Trifecta Pool, based upon the official order of finish. The minimum specified number of positions may be all three positions in all four races or a lesser specified number (for instance, 10 or more accurate positions within the four races taken as a whole).

Preferably, the net Quad Trifecta Pool is distributed as follows:

(a) The major share of the net Quad Trifecta Pool is distributed in accordance with the method for distributing the major share described above.

(b) A principal minor share of the net Quad Trifecta Pool may be designated, and distributed as a single price pool, to those who correctly selected finishers, in exact position, in the greatest number of positions in Quad Trifecta races (but less than the number of positions qualifying for the major share), based upon the official order of finish.

(c) Additional minor shares of the net Quad Trifecta Pool may be designated, and distributed as single price pools, to those who correctly selected the designated number, or range, of finishers, in exact position, in Quad Trifecta races (but less than the number of positions qualifying for the major share), based upon the official order of finish.

(d) Those qualifying for the major share may also qualify for the principal minor share and the additional minor shares. Also, those qualifying for the principal minor share may also qualify for the additional minor shares. When this occurs, the unbroken prices for each share shall be summed before surcharging or rounding the prices for breakage. For example:

Suppose there are $5 of wagers correctly selecting 9 positions, $3 of wagers selecting 10 positions, $2 of wagers selecting 11 positions, $2 of wagers selecting all 12 positions, and 12 is the greatest number of positions correctly selected. Suppose that the major share of the net pool is $100,000.00. Further, suppose that the principal minor share of the net pool is $20,000.40. and that one of the other minor shares is designated for a range of 9 to 11 positions, and this share of the net pool is $12,000.60. (These amounts are chosen only to illustrate the following steps.) Then the major share is divided among those selecting all 12 positions, the principal minor share is divided among those selecting 11 and 12 positions, and the other minor share is divided among all the wagers selecting 9, 10, 11, and 12 positions, so the 12-position winners receive the sum of three winning prices and the 11-position winners receive the sum of the principal minor and minor share winning prices. The principal minor share $20,000.60 divided among the $4 $2 of 11-or-more-position winners yields an unbroken price of $5,000.15 per dollar, and the other minor share $12,000.60 divided among the $12 of 9-or-more-position winners yields an unbroken price of $1,000.05 per dollar. The sum $100,000.00+$5,000.10+$1,000.05=$106,000.15 is the combined unbroken price for choosing all 12 finishers. The sum $5,000.10+$1,000.05=$6,000.15 is the combined unbroken price for choosing 11 or more finishers. If the rounding for breakage is to the next lower $0.10, the final broken prices are $106,000.10 for choosing all 12 finishers, $6,000.10 for choosing 11 or more finishers, and $1,000.00 for 9 or 10 finishers.

The appropriate racing authority may approve the number of minor shares, and the designated number, or range, of finishers, in exact position, in Quad Trifecta races qualifying as the winning selection in any such minor share. If there are no wagers qualifying for the major share, the major share may be added to the carryover. If there are no wagers qualifying for a designated minor share, the minor share of the net Quad Trifecta Pool may be combined with the major share for distribution as a single price pool to those who qualified for the major share, or if there are no such winning wagers, added to the carryover.

The appropriate racing authority may approve the method of apportioning the net Quad Trifecta Pool between winners of the Major share of the Quad Trifecta Pool and winners of the Minor share(s) of the Quad Trifecta Pool. For example: The major share may go to those who correctly choose all 12 positions. Assume one principal minor share and two minor shares have been approved: The principal minor share may go to those who have correctly picked 10 or 11 positions from the four Quad Trifecta races. The next minor share may go to those who have correctly picked 7, 8, or 9 positions from the four Quad Trifecta races. The final minor share may go to those who have correctly picked 4, 5, or 6 positions from the four Quad Trifecta races. One apportionment of payouts could be 40% of the net Quad Trifecta Pool for the major share, and 20% of the net Quad Trifecta Pool for each of the three minor shares. Another apportionment of payouts could be 50% of the net Quad Trifecta Pool for the major share, 25% for the highest minor share, 15% to the next minor share, and 10% to the final minor share.

Preferably, fields are prohibited in the four designated Quad Trifecta races. Coupled entries may be permitted in the four designated Quad Trifecta races with the approval of the appropriate racing authority. Contestants comprising a coupled entry may be considered part of a single betting interest for the purpose of price calculations and distribution of Quad Trifecta pools. Should any contestant in a coupled entry be officially withdrawn or scratched, the remaining contestants in that coupled entry shall remain valid betting interests and no refunds will be granted. For the purpose of Quad Trifecta price calculations only, coupled entries may be calculated as a single finishing contestant, using the finishing position of the leading contestant in that coupled entry or mutuel field to determine order of placing. This rule may apply to all circumstances, including situations involving a dead heat. For example, if the actual order of finish in a race is 1/2/1A/3/4, then the finishers used for that race of the Quad Trifecta would be 1/2/3/4.

If a dead heat or dead heats occur in any of the races of the Quad Trifecta, all Quad Trifecta tickets selecting the correct order of finish counting a horse in a dead heat as finishing in any position dead heated may be winning tickets, and contrary to the usual practice, the aggregate winning tickets may be divided into the net pool and be paid the same pay-off price. Wagering for the Quad Trifecta preferably closes at the same time that wagering is closed on the first designated race of the Quad Trifecta.

If an entire betting interest is scratched in a designated race of the Quad Trifecta while wagering on the Quad Trifecta is still open, preferably no more wagers are accepted selecting that betting interest, and any bettor who has previously placed a wager that includes one or more scratched betting interests among their selections may elect to cancel their wager and receive a refund. If, due to a late scratch, the number of betting interests in a race of the Quad Trifecta Pool is reduced to fewer than three, for purposes of the Quad Trifecta Pool only, such race may be declared “no contest.” For purposes of the Quad Trifecta Pool only, existing wagers that select a scratched betting interest are preferably treated as an incorrect selection. Other correctly selected finishers in a wager shall continue to count toward winning, as usual.

If any one or more of the Quad Trifecta races are cancelled or declared “no contest” at any time, any bettors who have previously placed a Quad Trifecta wager that includes a race that is cancelled or declared “no contest” may elect to cancel their wager and receive a refund at any time before the post time of the last Quad Trifecta race. If any one or more of the Quad Trifecta races are cancelled or declared “no contest” at any time, all selections from the cancelled contest may be treated as incorrect selections for purposes of determining participation in the major and minor shares, as appropriate. If any one or more of the Quad Trifecta races are cancelled or declared “no contest,” the net Quad Trifecta Pool may be distributed among the major share carryover and all minor share(s) in accordance with the rules governing distribution of the minor share(s) where there is no winner of the major share. If there is more than one minor share, the net Quad Trifecta Pool may be apportioned among the major share carryover and all minor share(s) in proportion to the designated percentages, or by some other approved method. If any of the remaining Quad Trifecta races are cancelled or declared “no contest” after the first Quad Trifecta is declared official, and the net Quad Trifecta Pool has been designated for distribution, the procedures governing mandatory distribution may apply.

If there is an undistributed net carryover, a carryover distribution may be declared, preferably at least 24 hours before the opening of Quad Trifecta wagering for that performance. If the Quad Trifecta carryover is designated for distribution on a specified date and performance, and if there are no wagers qualifying for the major share, then the following precedence may be followed in determining winning wagers for the net Quad Trifecta Pool and the carryover pool:

(a) The major share and the Quad Trifecta Pool carryover may be distributed as a single price pool to those who correctly selected the most finishers, in their exact positions, in the Quad Trifecta races, based upon the official order of finish. Designated minor shares may still be awarded.

(b) If there are no wagers which qualified for distribution of the major share, then all Quad Trifecta wagers may become winners and share 100% of that day's net Quad Trifecta Pool and the Quad Trifecta Pool carryover as a single price pool.

The Quad Trifecta Pool carryover may be designated for distribution on a specified date and performance only under one or more of the following circumstances:

(a) Upon declaration within 24 hours of the performance in which the first race comprising the Quad Trifecta wager occurs;

(b) Upon written approval from the appropriate racing authority when there is a change in the carryover cap or when the Quad Trifecta wager is discontinued;

(c) On the closing performance of the meet; or

(d) Upon such other conditions as the appropriate racing authority may approve.

Thus, what has been described is a method and system for conducting pari-mutuel betting, which is attractive to many bettors, provides for increased jackpots, is easy to understand by the typical bettor, and provides multiple tiers of prizes.

The individual components shown in outline or designated by blocks in the attached Drawings are all well-known in the wagering arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claim. The scope of the following claim is to be accorded the broadest interpretation so as to encompass all such modifications and equivalent structures and functions.

All U.S. patent documents discussed above are hereby incorporated by reference into the Detailed Description of the Preferred Embodiment.

What is claimed is:

1. A racing wager method, comprising the steps of:
providing a bettor with a selection from among a plurality of runners at four races;
accepting a wager from the bettor, said wager comprising (i) a monetary amount, and (ii) the bettor's selection of runners for the first, second, and third place finishers for each of the four races; and
providing monetary value to a bettor whose wager meets a predetermined wager success criteria.
